(19) United States
(12) Patent Application Publication
(10) Pub. No.: US 2026/0210484 A1
(43) Pub. Date: Jul. 23, 2026

(54) ELECTRONIC APPARATUS SUPPORTING DEVICE

(71) Applicant: Ming-Hsien Huang, New Taipei City (TW)

(72) Inventor: Ming-Hsien Huang, New Taipei City (TW)

(21) Appl. No.: 19/334,978

(22) Filed: Sep. 22, 2025

Related U.S. Application Data
(60) Provisional application No. 63/747,367, filed on Jan. 21, 2025.

(30) Foreign Application Priority Data
Jul. 30, 2025 (TW) 114207913

(51) Int. Cl. F16M 11/10

(52) U.S. Cl. CPC F16M 11/10; F16M 2200/022

(57) ABSTRACT

An electronic apparatus supporting device includes a protruding neck member, a bearing frame, and a torsion adjustment structure. The bearing frame bears the electronic apparatus and is pivotally connected to the protruding neck member. The torsion adjustment structure is positioned between the protruding neck member and the bearing frame and includes a positioning seat fixed to the protruding neck member, an adjustment screw screwed to the positioning seat, an abutting member slidably disposed in the positioning seat, and at least one torsion spring constantly providing a total elastic force to the bearing frame and having a first end abutting against the bearing frame and a second end accommodated in the positioning seat. An end of the adjustment screw and the second end of the torsion spring abut against two opposite sides of the abutting member. The magnitude of the total elastic force can be adjusted by rotating the adjustment screw.

### CROSS-REFERENCE TO RELATED APPLICATION

This application claims the priority benefit of U.S. Provisional Application No. 63/747,367, filed on January 21, 2025 and Taiwan Application No. 114207913, filed on July 30, 2025. The entirety of each of the above-mentioned patent applications is hereby incorporated by reference herein and made a part of this specification.

### BACKGROUND

### Technical Field

The disclosure relates to a supporting device, and in particular, relates to an electronic apparatus supporting device.

### Description of Related Art

A common electronic apparatus (e.g., a monitor, a tablet computer, or other similar apparatuses) may be disposed on a supporting module and may further be matched with a stand to be placed on a work surface or matched with a wall mount to be mounted on a wall, so that a user may perform viewing or operating easily. Generally, the supporting module integrates a rotation mechanism for users to adjust a tilt angle of the electronic apparatus disposed on the supporting module according to personal needs.

Further, the rotation mechanism may apply a fixed torque to the electronic apparatus to balance the torque caused by the gravity of the electronic apparatus disposed on the supporting module. Since the torque of the rotation mechanism cannot be easily adjusted, it cannot be universally applied to electronic apparatus of different weights. On the other hand, when the torque of the rotation mechanism cannot balance the torque caused by the gravity of the electronic apparatus, the process of adjusting the tilt angle of the electronic apparatus will be hindered, which is both time-consuming and laborious.

### SUMMARY

The disclosure provides an electronic apparatus supporting device capable of improving operational smoothness.

The disclosure provides an electronic apparatus supporting device for supporting an electronic apparatus, and the electronic apparatus supporting device includes a protruding neck member, a bearing frame, and a torsion adjustment structure. The bearing frame is configured to bear the electronic apparatus and is pivotally connected to the protruding neck member. The torsion adjustment structure is positioned between the protruding neck member and the bearing frame and includes a positioning seat, an adjustment screw, an abutting member, and at least one torsion spring. The positioning seat is fixed to the protruding neck member. The adjustment screw is screwed to the positioning seat. The abutting member is slidably disposed in the positioning seat. The torsion spring constantly provides a total elastic force to the bearing frame and has a first end abutting against the bearing frame and a second end accommodated in the positioning seat. An end of the adjustment screw and the second end of the torsion spring abut against two opposite sides of the abutting member. When the adjusting screw is rotated to gradually move in a first direction, the abutting member is pushed to gradually move in the first direction, and the second end of the torsion spring is pushed consequentially, so that the total elastic force gradually increases. When the adjusting screw is rotated to gradually move in a second direction opposite to the first direction, the abutting member is restored by the second end of the torsion spring and gradually moves in the second direction, and the total elastic force gradually decreases.

In an embodiment of the disclosure, the adjustment screw and the abutting member substantially move synchronously in the first direction or in the second direction.

In an embodiment of the disclosure, the positioning seat has a guide slot, a first side wall, and a second side wall. The first side wall and the second side wall are cooperatively connected and define the guide slot together. The first side wall forms a first internal thread region on a side adjacent to the guide slot. The second side wall forms a second internal thread region on a side adjacent to the guide slot. The first internal thread region and the second internal thread region are correspondingly matched for the adjustment screw to be screwed. The abutting member is slidably disposed in the guide slot.

In an embodiment of the disclosure, the positioning seat further has a first through slot formed in the first side wall. The first through slot communicates with the guide slot. The second end of the torsion spring passes through the first through slot and extends into the guide slot.

In an embodiment of the disclosure, the positioning seat further has a second through slot formed in the second side wall. The second through slot communicates with the guide slot. The second end of the torsion spring passes through the guide slot and extends into the second through slot.

In an embodiment of the disclosure, the protruding neck member has a through hole positioned opposite to the first internal thread region and the second internal thread region. The adjustment screw passes through the through hole to be screwed to the first internal thread region and the second internal thread region.

In an embodiment of the disclosure, the first internal thread region, the second internal thread region, and a portion of the guide slot are matched and form together a substantially equivalent screw hole corresponding to the adjustment screw.

In an embodiment of the disclosure, each of the first internal thread region and the second internal thread region is an arc-shaped groove communicating with the guide slot and having an internal thread and corresponds to a same center on a cross section perpendicular to a gravity direction.

In an embodiment of the disclosure, the electronic apparatus supporting device further includes a positioning shaft. The positioning shaft is disposed through the protruding neck member and the bearing frame, and the torsion spring is sleeved on the positioning shaft.

In an embodiment of the disclosure, the electronic apparatus supporting device further includes a bushing. The bushing is sleeved on the positioning shaft, and the torsion spring is sleeved on the bushing.

In an embodiment of the disclosure, the abutting member includes a first rod portion and two second rod portions arranged in parallel and connected to the first rod portion. The end of the adjustment screw and the second end of the torsion spring abut against opposite sides of the first rod portion. The second end of the torsion spring is positioned between the two second rod portions.

In an embodiment of the disclosure, when the adjustment screw moves in the first direction or the second direction, the second rod portions abut against the first side wall and the second side wall respectively, so that a guiding effect is generated, and the abutting member is prevented from being crooked relative to the positioning seat.

In an embodiment of the disclosure, the at least one torsion spring is plural, and each second end of each of the torsion springs abuts against the abutting member.

To sum up, the electronic apparatus supporting device of the disclosure is able to adjust torsion according to the weight of the disposed electronic apparatus.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIGS. 1A and FIG. 1B are schematic views of an electronic apparatus supporting device from two different viewing angles according to an embodiment of the disclosure.

FIG. 1C is a schematic view of the electronic apparatus supporting device matched and used together with a stand according to an embodiment of the disclosure.

FIGS. 2A and FIG. 2B are exploded schematic views of the electronic apparatus supporting device from two different viewing angles according to an embodiment of the disclosure.

FIG. 3A is a rear schematic view of the electronic apparatus supporting device according to an embodiment of the disclosure.

FIG. 3B is a cross-sectional schematic view taken along a line I-I of FIG. 3A, illustrating a setting state where a total elastic force is relatively small.

FIG. 3C is a cross-sectional schematic view of FIG. 3A converted to a setting state where the total elastic force is relatively large.

FIG. 3D is a top schematic view of a positioning seat of FIG. 2A.

### DESCRIPTION OF THE EMBODIMENTS

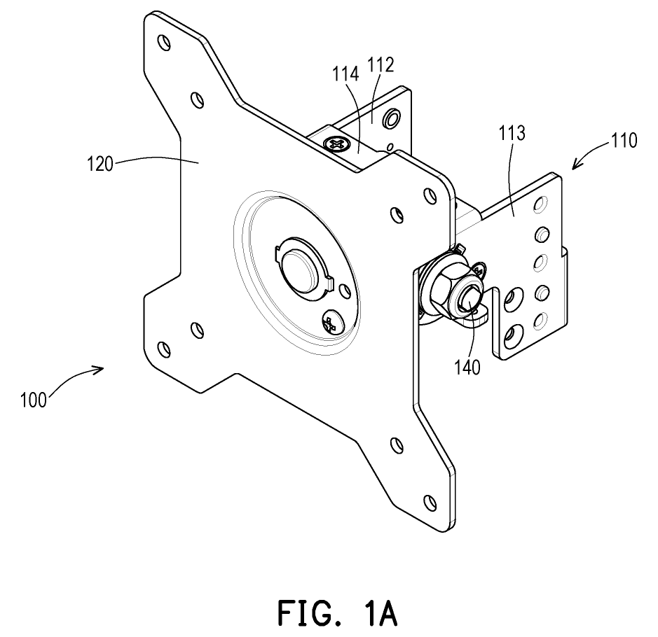

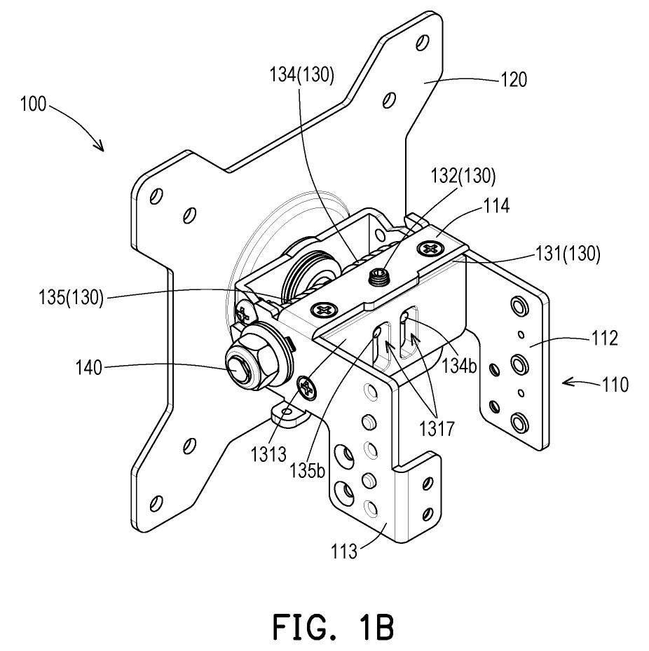

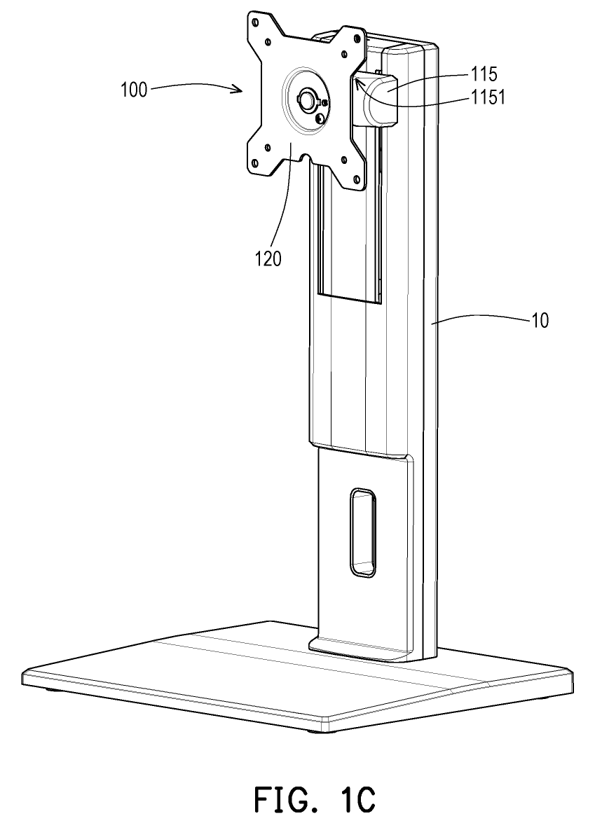

Referring to FIGS. 1A to FIG. 1C, in this embodiment, an electronic apparatus supporting device 100 for supporting an electronic apparatus (not shown) includes a protruding neck member 110, a bearing frame 120 (i.e., a VESA frame), and a torsion adjustment structure 130. The bearing frame 120 is pivotally connected to the protruding neck member 110, and the torsion adjustment structure 130 is positioned between the protruding neck member 110 and the bearing frame 120.

The electronic apparatus supporting device 100 may be matched with a stand 10 to be placed on a working surface, for facilitating being easily viewed or operated for users. In detail, one end of the protruding neck member 110 is connected to the bearing frame 120, and the other end of the protruding neck member 110 is connected to the stand 10. On the other hand, the electronic apparatus (not shown) such as a display may be disposed on the bearing frame 120, and a tilt angle of the electronic apparatus (not shown) may be adjusted through rotation of the bearing frame 120 relative to the protruding neck member 110. In other embodiments, the electronic apparatus supporting device may be matched with a wall mount to be attached on a wall.

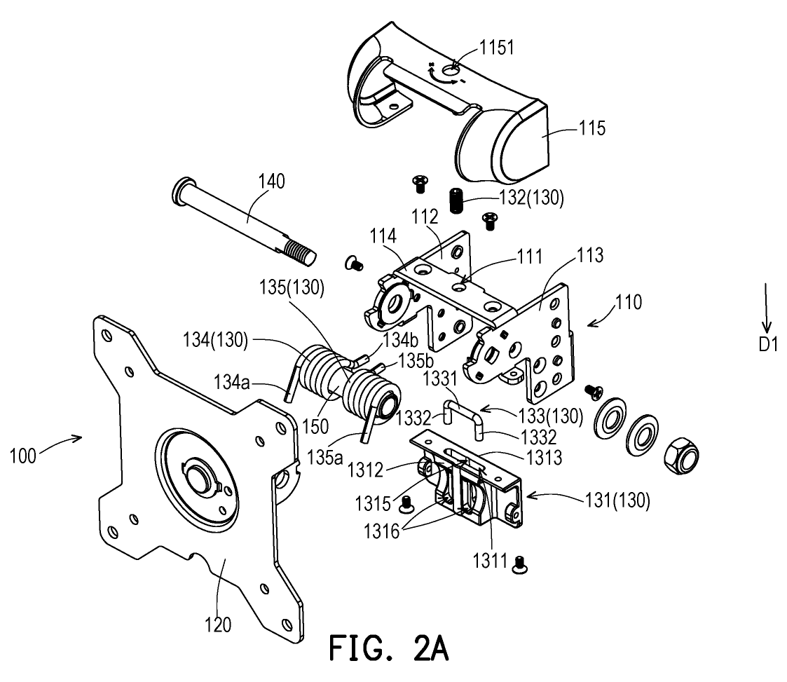

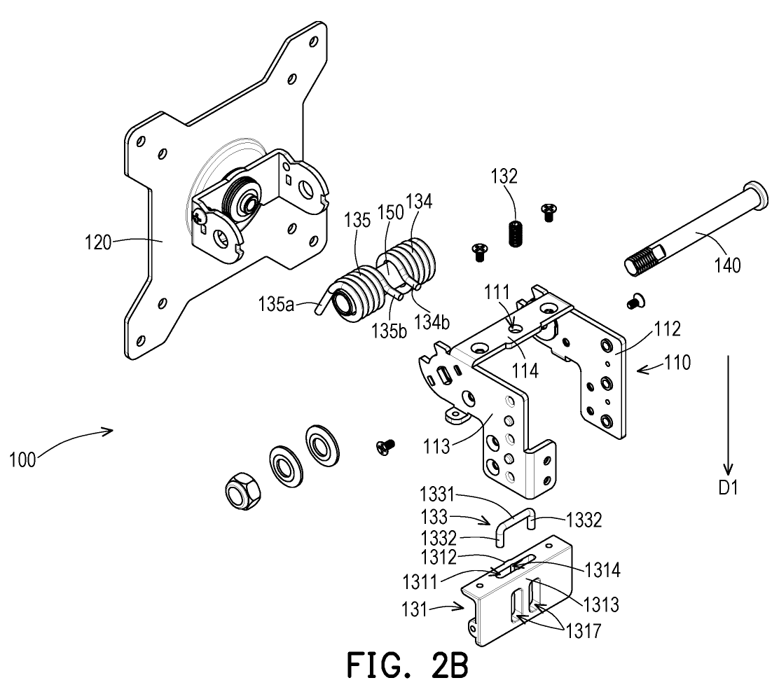

Referring to FIGS. 2A and FIG. 2B next, the protruding neck member 110 includes a through hole 111, a first plate body 112, a second plate body 113, a connecting plate 114, and a housing 115. The first plate body 112 and the second plate body 113 are spaced apart, disposed substantially parallel to each other, and connected to the stand 10. The connecting plate 114 connects the first plate body 112 and the second plate body 113, and the through hole 111 is formed in the connecting plate 114. The housing 115 covers the first plate body 112, the second plate body 113 and the connecting plate 114, and has an adjustment hole 1151 aligned with the through hole 111. In this embodiment, the first plate body 112, the second plate body 113, and the connecting plate 114 integrally form a stamping member, but the disclosure is not limited thereto.

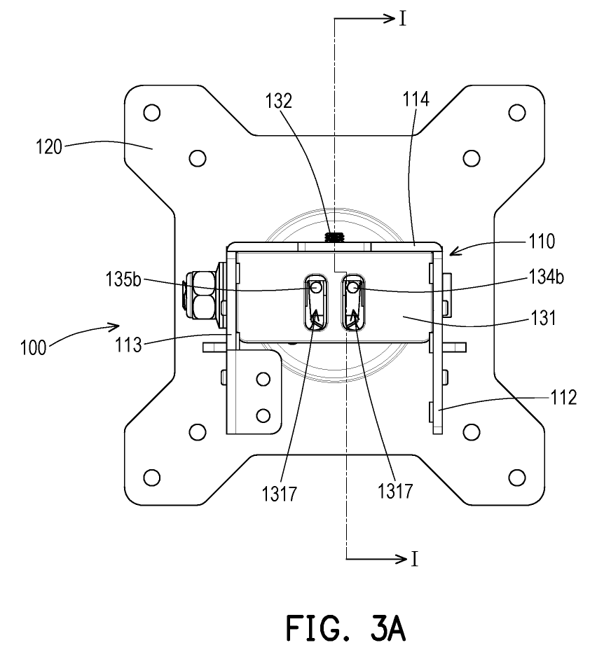

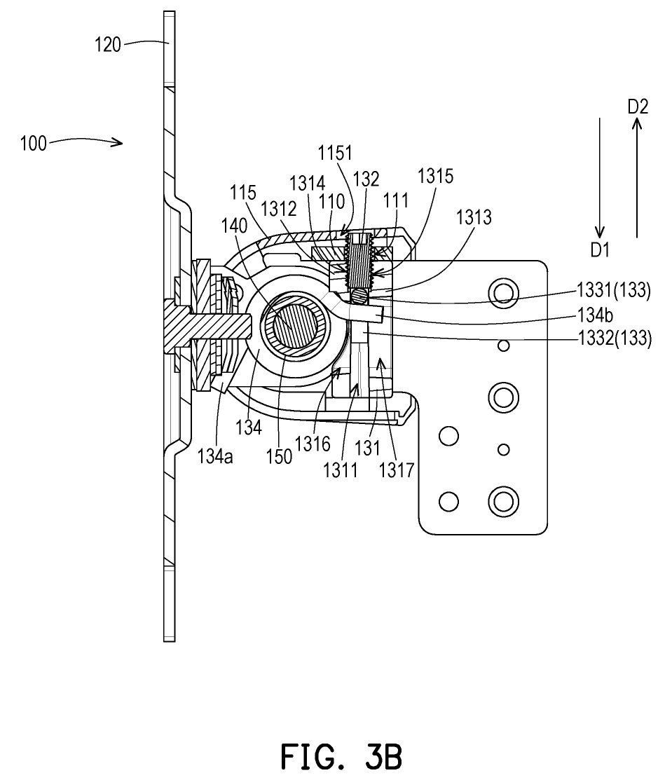

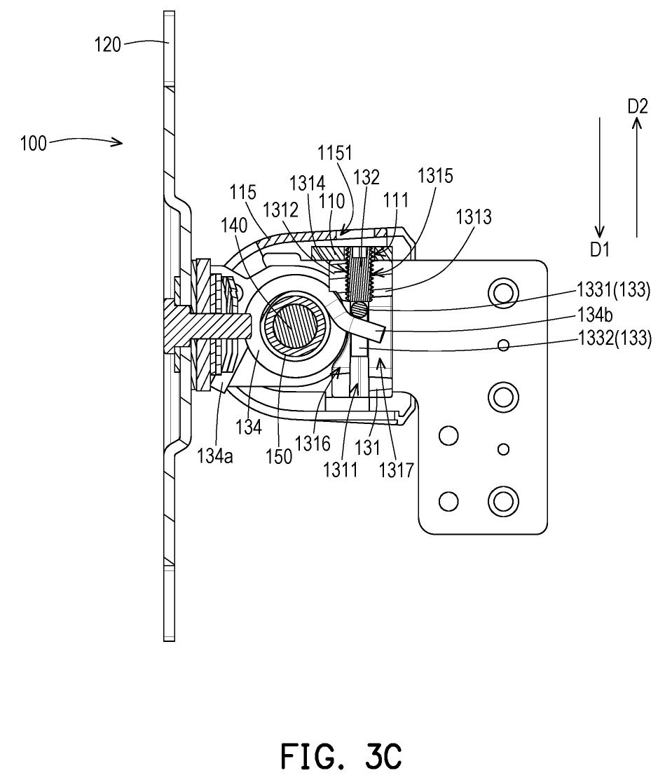

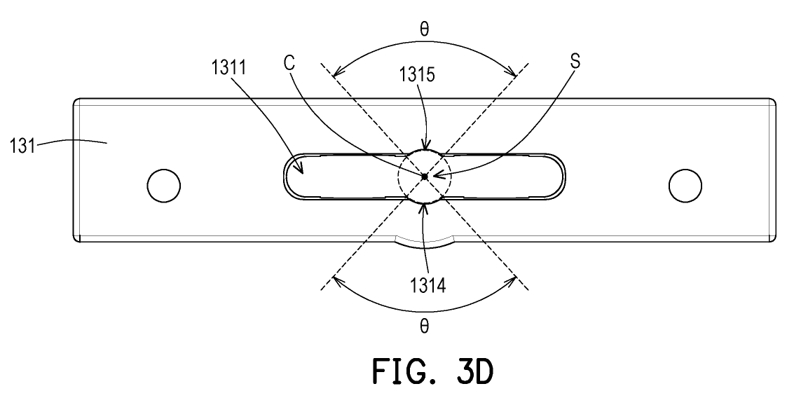

In this embodiment, the torsion adjustment structure 130 includes a positioning seat 131, an adjustment screw 132, an abutting member 133, a first torsion spring 134, and a second torsion spring 135. The positioning seat 131 is fixed to the protruding neck member 110, for example, by screw fastening. Moreover, the positioning seat 131 is sandwiched between the first plate body 112 and the second plate body 113 and is substantially stacked with the connecting plate 114 in a gravity direction that is in a same direction as a first direction D1. Referring additionally to FIGS. 3A and FIG. 3B, the adjustment screw 132 is aligned with the adjustment hole 1151 of the housing 115 and is screwed to the positioning seat 131 after passing through the through hole 111 of the protruding neck member 110.

The abutting member 133 is substantially a U-shaped rod and is slidably disposed on the positioning seat 131. An end of the adjustment screw 132 screwed to the positioning seat 131 abuts against one side of the abutting member 133. On the other hand, the first torsion spring 134 has a first end 134a abutting against the bearing frame 120 and a second end 134b accommodated in the positioning seat 131. Similarly, the second torsion spring 135 has a first end 135a abutting against the bearing frame 120 and a second end 135b accommodated in the positioning seat 131.

Furthermore, the second end 134b of the first torsion spring 134 and the second end 135b of the second torsion spring 135 both abut against the other side of the abutting member 133. Moreover, the abutting member 133 maintains the first torsion spring 134 and the second torsion spring 135 in a pre-compressed state (or energy-stored state), so that the first torsion spring 134 and the second torsion spring 135 provide a total elastic force to the bearing frame 120 and form a torque applied to the bearing frame 120.

Referring to FIG. 3B again, at this time the first torsion spring 134 and the second torsion spring 135 are pre-compressed to a lesser degree, for corresponding to a relatively lighter electronic apparatus (not shown) disposed on the bearing frame 120. Further through compensating of a friction force, the user may thereby easily and quickly adjust the tilt angle of the electronic apparatus (not shown).

Additionally, referring to FIG. 3C next, at this time the first torsion spring 134 and the second torsion spring 135 are pre-compressed to a greater degree, for corresponding to a relatively heavier electronic apparatus (not shown) disposed on the bearing frame 120. Further, through the compensation of a friction force, the user may thereby easily and quickly adjust the tilt angle of the electronic apparatus (not shown).

To be specific, to adjust from FIGS. 3B to FIG. 3C (i.e., increasing the degree of pre-compression), users may use a screwdriver or other auxiliary tools. By letting the screwdriver penetrate through the adjustment hole 1151 of the housing 115 for abutting against and rotating the adjustment screw 132, the adjustment screw 132 is then enabled to gradually move in the first direction D1 and to push the abutting member 133 for gradually moving in the first direction D1, so that the second end 134b of the first torsion spring 134 and the second end 135b of the second torsion spring 135 are pushed. An elastic deformation amount of the first torsion spring 134 and the second torsion spring 135 is thus gradually increased, so as to gradually increase the total elastic force provided by the first torsion spring 134 and the second torsion spring 135 to the bearing frame 120.

Conversely, to adjust from FIGS. 3C to FIG. 3B (i.e., reducing the degree of pre-compression), users may similarly use a screwdriver or other auxiliary tools to rotate the adjustment screw 132, so that the adjustment screw 132 gradually moves in a second direction D2 opposite to the first direction D1. The second end 134b of the first torsion spring 134 and the second end 135b of the second torsion spring 135 generate elastic restoration, so as to drive the abutting member 133 for gradually moving in the second direction D2.

When the second end 134b of the first torsion spring 134 and the second end 135b of the second torsion spring 135 generate elastic restoration, the elastic deformation amount of the first torsion spring 134 and the second torsion spring 135 gradually decreases, so as to gradually reduce the total elastic force provided by the first torsion spring 134 and the second torsion spring 135 to the bearing frame 120. Further, the torque applied by the first torsion spring 134 and the second torsion spring 135 on the bearing frame 120 is also reduced.

That is, users may rotate the adjustment screw 132 according to a weight of the electronic apparatus (not shown) and adjust the total elastic force provided by the first torsion spring 134 and the second torsion spring 135 to the bearing frame 120 together with the abutting member 133, so as to achieve the purpose of adjusting the torque applied on the bearing frame 120.

On the other hand, in the process of adjusting the total elastic force provided by the first torsion spring 134 and the second torsion spring 135 to the bearing frame 120, the movement of the adjustment screw 132, the abutting member 133, the second end 134b of the first torsion spring 134, and the second end 135b of the second torsion spring 135 is substantially synchronized. As the total elastic force increases, the adjustment screw 132, the abutting member 133, the second end 134b of the first torsion spring 134, and the second end 135b of the second torsion spring 135 substantially move synchronously in the first direction D1. Conversely, as the total elastic force decreases, the adjustment screw 132, the abutting member 133, the second end 134b of the first torsion spring 134, and the second end 135b of the second torsion spring 135 substantially move synchronously in the second direction D2.

Additionally, in this embodiment, the positioning seat 131 has a guide slot 1311, a first side wall 1312, and a second side wall 1313. The first side wall 1312 and the second side wall 1313 are cooperatively connected and define the guide slot 1311 together. In detail, the first side wall 1312 forms a first internal thread region 1314 on a side adjacent to the guide slot 1311 or facing the second side wall 1313, and the second side wall 1313 forms a second internal thread region 1315 on a side adjacent to the guide slot 1311 or facing the first side wall 1312.

Each of the first internal thread region 1314 and the second internal thread region 1315 may communicate with the guide slot 1311 and is an arc-shaped groove having an internal thread. Referring to FIG. 3D next, on a cross section perpendicular to the gravity direction that is the same direction as the first direction D1, the first internal thread region 1314 and the second internal thread region 1315 correspond to a same center C and substantially have a same central angle θ, with the angle being, for example, between 30 degrees and 120 degrees. The first internal thread region 1314 is positioned opposite to the second internal thread region 1315 and extends substantially in the first direction D1 within the guide slot 1311. On the other hand, the first internal thread region 1314 and the second internal thread region 1315 are correspondingly matched for the adjustment screw 132 to be screwed. Moreover, the first internal thread region 1314, the second internal thread region 1315, and a portion of the guide slot 1311 are matched and form together a substantially equivalent screw hole S (as shown by the dashed circle in FIG. 3D) corresponding to the adjustment screw 132. The abutting member 133 is slidably disposed in the guide slot 1311.

To take it a step further, the adjustment screw 132 passes through the through hole 111 and is screwed to the first internal thread region 1314 and the second internal thread region 1315. On the other hand, in the first direction D1, the first internal thread region 1314 and the second internal thread region 1315 are positioned opposite to the through hole 111 and substantially fall within a projection range of the through hole 111.

In addition, the positioning seat 131 further has two first through slots 1316 formed on the first side wall 1312, and the two first through slots 1316 communicate with the guide slot 1311. In detail, the second end 134b of the first torsion spring 134 and the second end 135b of the second torsion spring 135 pass through the two first through slots 1316 and extend into the guide slot 1311, so as to abut against the abutting member 133.

Similarly, the positioning seat 131 further has two second through slots 1317 formed on the second side wall 1313. Specifically, the two second through slots 1317 are positioned opposite to the two first through slots 1316 and communicate with the guide slot 1311. On the other hand, the second end 134b of the first torsion spring 134 and the second end 135b of the second torsion spring 135 both pass through the guide slot 1311 and extend into the two second through slots 1317.

The second end 134b of the first torsion spring 134 and the second end 135b of the second torsion spring 135 are prevented from generating offset during the process of elastic deformation or elastic restoration by matching of each first through slot 1316 with the corresponding second through slot 1317.

In other embodiments, a number of torsion springs may be increased or decreased according to actual design needs, and a number of first through slots and second through slots of the positioning seat may be correspondingly increased or decreased according to the number of torsion springs. Additionally, the second through slots may be selectively omitted.

Further, the abutting member 133 includes a first rod portion 1331 and two second rod portions 1332 arranged in parallel, connected to opposite ends of the first rod portion 1331 respectively, and extend outwardly at an angle. Herein, the end of the adjustment screw 132 abuts against one side of the first rod portion 1331, and the second end 134b of the first torsion spring 134 and the second end 135b of the second torsion spring 135 both abut against the other side of the first rod portion 1331.

On the other hand, the second end 134b of the first torsion spring 134 and the second end 135b of the second torsion spring 135 are both positioned between the two second rod portions 1332, so that the second end 134b of the first torsion spring 134 and the second end 135b of the second torsion spring 135 are prevented from departing from the first rod portion 1331 during the processes of elastic deformation or elastic restoration. Further, the second rod portions 1332 have guiding functions. During the process of elastic deformation or elastic restoration (i.e., during the process when the adjustment screw 132 gradually moves in the first direction D1 or the second direction D2), the second rod portions 1332 abut against the first side wall 1312 and the second side wall 1313 respectively, so as to prevent the abutting member 133 from being crooked relative to the positioning seat 131 and getting stuck.

Moreover, the electronic apparatus supporting device 100 further includes a positioning shaft 140 passing through the protruding neck member 110 and the bearing frame 120. Further, the first torsion spring 134 and the second torsion spring 135 are both sleeved on the positioning shaft 140. On the other hand, the positioning shaft 140 cannot rotate relative to the protruding neck member 110, and the bearing frame 120 may rotate relative to the positioning shaft 140, so as to adjust an angle of the bearing frame 120 relative to the protruding neck member 110.

Additionally, the electronic apparatus supporting device 100 further includes a bushing 150 sleeved on the positioning shaft 140. Further, the first torsion spring 134 and the second torsion spring 135 are both sleeved on the bushing 150 to be indirectly sleeved on the positioning shaft 140.

In view of the foregoing, the user may rotate the adjustment screw according to the weight of the electronic apparatus and adjust the total elastic force provided by one or more torsion springs to the bearing frame together with the abutting member, so as to adjust the torque applied to the bearing frame.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic apparatus supporting device, for supporting an electronic apparatus, and the electronic apparatus supporting device comprising:
a protruding neck member;
a bearing frame configured to bear the electronic apparatus and pivotally connected to the protruding neck member; and
a torsion adjustment structure positioned between the protruding neck member and the bearing frame and comprising:
a positioning seat fixed to the protruding neck member;
an adjustment screw screwed to the positioning seat;
an abutting member slidably disposed in the positioning seat; and
at least one torsion spring constantly providing a total elastic force to the bearing frame and having a first end abutting against the bearing frame and a second end accommodated in the positioning seat, wherein an end of the adjustment screw and the second end of the at least one torsion spring abut against two opposite sides of the abutting member,
wherein when the adjusting screw is rotated to gradually move in a first direction, the abutting member is pushed to gradually move in the first direction, and the second end of the at least one torsion spring is pushed consequentially, so that the total elastic force gradually increases, and
wherein when the adjusting screw is rotated to gradually move in a second direction opposite to the first direction, the abutting member is restored by the second end of the at least one torsion spring and gradually moves in the second direction, and the total elastic force gradually decreases.

2. The electronic apparatus supporting device according to claim 1, wherein the adjustment screw and the abutting member substantially move synchronously in the first direction or in the second direction.

3. The electronic apparatus supporting device according to claim 1, wherein the positioning seat has a guide slot, a first side wall, and a second side wall, the first side wall and the second side wall are cooperatively connected and define the guide slot together, the first side wall forms a first internal thread region on a side adjacent to the guide slot, the second side wall forms a second internal thread region on a side adjacent to the guide slot, the first internal thread region and the second internal thread region are correspondingly matched for the adjustment screw to be screwed, and the abutting member is slidably disposed in the guide slot.

4. The electronic apparatus supporting device according to claim 3, wherein the positioning seat further has a first through slot formed in the first side wall, the first through slot communicates with the guide slot, and the second end of the at least one torsion spring passes through the first through slot and extends into the guide slot.

5. The electronic apparatus supporting device according to claim 3, wherein the positioning seat further has a second through slot formed in the second side wall, the second through slot communicates with the guide slot, and the second end of the at least one torsion spring passes through the guide slot and extends into the second through slot.

6. The electronic apparatus supporting device according to claim 3, wherein the protruding neck member has a through hole positioned opposite to the first internal thread region and the second internal thread region, and the adjustment screw passes through the through hole to be screwed to the first internal thread region and the second internal thread region.

7. The electronic apparatus supporting device according to claim 3, wherein the first internal thread region, the second internal thread region, and a portion of the guide slot are matched and form together a substantially equivalent screw hole corresponding to the adjustment screw.

8. The electronic apparatus supporting device according to claim 3, wherein each of the first internal thread region and the second internal thread region is an arc-shaped groove communicating with the guide slot and having an internal thread and corresponds to a same center on a cross section perpendicular to a gravity direction.

9. The electronic apparatus supporting device according to claim 1, further comprising:
a positioning shaft disposed through the protruding neck member and the bearing frame, wherein the at least one torsion spring is sleeved on the positioning shaft.

10. The electronic apparatus supporting device according to claim 9, further comprising:
a bushing sleeved on the positioning shaft, wherein the at least one torsion spring is sleeved on the bushing.

11. The electronic apparatus supporting device according to claim 3, wherein the abutting member comprises a first rod portion and two second rod portions arranged in parallel and connected to the first rod portion, the end of the adjustment screw and the second end of the at least one torsion spring abut against opposite sides of the first rod portion, and the second end of the at least one torsion spring is positioned between the two second rod portions.

12. The electronic apparatus supporting device according to claim 11, wherein when the adjustment screw moves in the first direction or the second direction, the second rod portions abut against the first side wall and the second side wall respectively, so that a guiding effect is generated, and the abutting member is prevented from being crooked relative to the positioning seat.

13. The electronic apparatus supporting device according to claim 1, wherein the at least one torsion spring is plural, and each second end of each of the torsion springs abuts against the abutting member.
